(19) United States
(12) Patent Application Publication
(10) Pub. No.: US 2021/0184541 A1
(43) Pub. Date: Jun. 17, 2021

(54) ELECTRIC ROTATING MACHINE

(71) Applicant: Mitsubishi Electric Corporation, Tokyo (JP)

(72) Inventors: Tadashi MURAKAMI, Tokyo (JP); Toshiyuki YOSHIZAWA, Tokyo (JP); Naohide MAEDA, Tokyo (JP); Jun TAHARA, Tokyo (JP); Hiroyuki HIGASHINO, Tokyo (JP); Yuki HIDAKA, Tokyo (JP)

(73) Assignee: Mitsubishi Electric Corporation, Tokyo (JP)

(21) Appl. No.: 17/087,975

(22) Filed: Nov. 3, 2020

(30) Foreign Application Priority Data
Dec. 13, 2019 (JP) 2019-225041

(51) Int. Cl. H02K 9/06; H02K 1/24; H02K 9/00; H02K 21/04; H02K 1/22

(52) U.S. Cl. CPC H02K 9/06; H02K 1/243; H02K 1/226; H02K 21/04; H02K 9/005

(57) ABSTRACT

In order to provide an electric rotating machine which is inexpensive and miniaturized while improving cooling performance of a rotor, a power supply unit is fixed on the axial side of a shaft in a bracket and a permanent magnet is arranged adjacent to the advancing side in the rotation direction of a claw-shaped magnetic pole portion of a magnetic pole on the side where the power supply unit is provided.

### BACKGROUND OF THE INVENTION

### 1. Field of the Invention

The present application relates to an electric rotating machine into which a power supply unit is integrated.

### 2. Description of the Related Art

In a magnet combination type vehicular alternating current (AC) generator in which a permanent magnet is arranged between claw portions of magnetic poles of a Lundell type rotor, there is known a structure in which a configuration is made such that the total number of the inter-pole magnets is fewer than that of the claw-shaped magnetic poles.

For example, in an electric rotating machine described in Patent Document 1, a rotor includes a field magnet provided between a first claw-shaped magnetic pole and a second claw-shaped magnetic pole and the field magnet is alternately arranged.

Patent Document 1: JP-A-H11(1999)-98787

When such a structure is adopted in an electric rotating machine into which a power supply unit is integrated, a pressure loss on the power supply unit side is larger than that on the anti-power supply unit side and the amount of air intake to an electric motor on the power supply unit side is smaller than that on the anti-power supply unit side. Accordingly, when the magnet is arranged at a position where cooling air sent from the anti-power supply unit side is blocked, the pressure loss is increased and the amount of flow of the cooling air is reduced; thus, a heat transfer coefficient is reduced. Further, an air intake port needs to be enlarged and it causes an increase in size and weight.

Furthermore, particularly, when the electric rotating machine is mounted in an engine room of a motor vehicle, the electric rotating machine is required to be placed in a limited space. In a type of vehicle in which a radial space can only be slightly secured, it causes a trouble in which components interfere with each other, there is a trouble in which a working space for attaching a connection connector to an external device or a fixing screw cannot be secured; and, at worst, there is a case where the electric rotating machine cannot be placed due to no allowance for the size. As just described, a problem exists in that mounting is constrained due to the layout in the engine room. In addition, high cooling property is required in an electric motor mounted on a hybrid vehicle (HV) or the like; in the case of a large temperature rise, current density needs to be reduced and it causes a deterioration in performance; and/or, a problem exists in that a high heat resistant component is used and accordingly it causes an increase in cost.

### BRIEF SUMMARY OF THE INVENTION

In view of the foregoing problem, an object of the present application is to provide an electric rotating machine which is inexpensive and miniaturized while improving cooling performance of a rotor.

The electric rotating machine disclosed in the present application is an electric rotating machine which includes: a rotor configured to include magnetic poles in which a plurality of claw-shaped magnetic pole portions are provided on the outer circumference thereof, a field winding wound around the magnetic poles, and a shaft that rotates integrally with the magnetic poles and the field winding; a stator configured to include a stator core arranged in face-to-face relation to the outer circumference of the magnetic poles, and a stator winding wound around the stator core; a permanent magnet configured to be disposed between the adjacent claw-shaped magnetic pole portions of the magnetic poles, and to be magnetized in a direction reducing leakage magnetic flux between the adjacent claw-shaped magnetic pole portions; a cooling fan configured to be provided on at least one of the axial sides of the shaft in the magnetic poles, and to cool the field winding and the permanent magnet; brackets configured to contain the stator and the rotor, and to support the shaft rotatably; and a power supply unit configured to supply power to the stator winding or the field winding. In the electric rotating machine, the power supply unit is configured to be fixed on the axial side of the shaft of the bracket; and the permanent magnet is configured to be arranged on the advancing side in the rotation direction of the claw-shaped magnetic pole portion of the magnetic pole on the side where the power supply unit is provided.

According to the electric rotating machine disclosed in the present application, the permanent magnet is arranged on the advancing side in the rotation direction of the claw-shaped magnetic pole portions of the magnetic pole on the power supply unit side, whereby cooling can be made without blocking cooling air sent from the anti-power supply unit side where the amount of airflow is large. Furthermore, cooling property of the field winding is improved and therefore continuous output can be improved. Further, cooling performance of the permanent magnet can be improved and therefore an inexpensive permanent magnet can be used.

### BRIEF DESCRIPTION OF THE SEVERAL VIEWS OF THE DRAWINGS

FIG. 1 is a relevant part sectional view of an electric rotating machine according to Embodiment 1;

FIG. 2 is an outline view showing an example of a rotor in a lateral arrangement in the electric rotating machine according to Embodiment 1;

FIG. 3 is a view in which the rotor in the electric rotating machine according to Embodiment 1 is seen from the power supply unit side;

FIG. 4 is an outline view showing an example of the rotor in a longitudinal arrangement in the electric rotating machine according to Embodiment 1;

FIG. 5 is a typical view for explaining cooling air flowing through the rotor according to Embodiment 1;

FIG. 6 is an outline view showing a rotor in a lateral arrangement in an electric rotating machine according to Embodiment 2;

FIG. 7 is a view in which the rotor is seen from the power supply unit side in the electric rotating machine according to Embodiment 2;

FIG. 8 is an overview view showing a relevant part of a rotor in an electric rotating machine according to Embodiment 3;

FIG. 9 is an overview view showing a relevant part of a rotor in an electric rotating machine according to Embodiment 4;

FIG. 10 is an overview view showing a relevant part of a rotor in an electric rotating machine according to Embodiment 5; and

FIG. 11 is a relevant part sectional view of an electric rotating machine according to Embodiment 6.

### DETAILED DESCRIPTION OF THE INVENTION

Hereinafter, preferred embodiments of an electric rotating machine according to the present application will be described using drawings. Then, in each of the drawings, identical or equivalent members and portions will be described with the same reference numerals (and letters) assigned thereto. Incidentally, a constitutional portion in one drawing and the identical and/or equivalent constitutional portion in another drawing are each shown in an independent size and in an independent scale.

### Embodiment 1

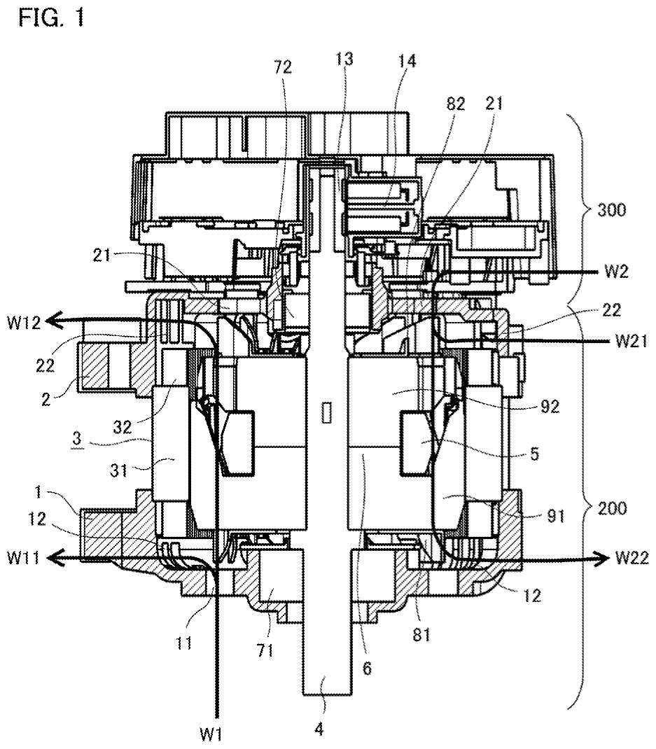

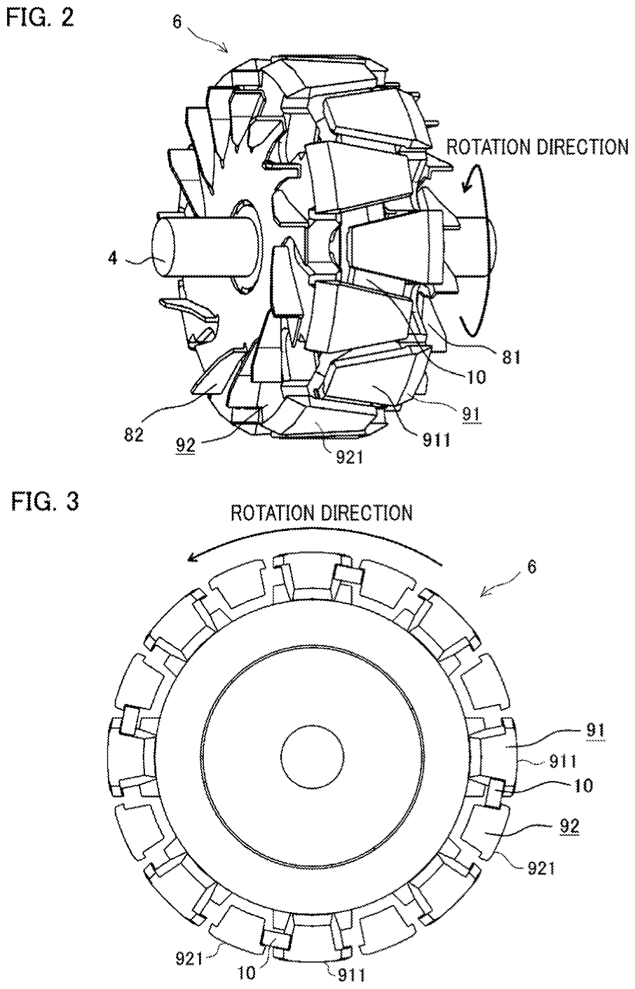

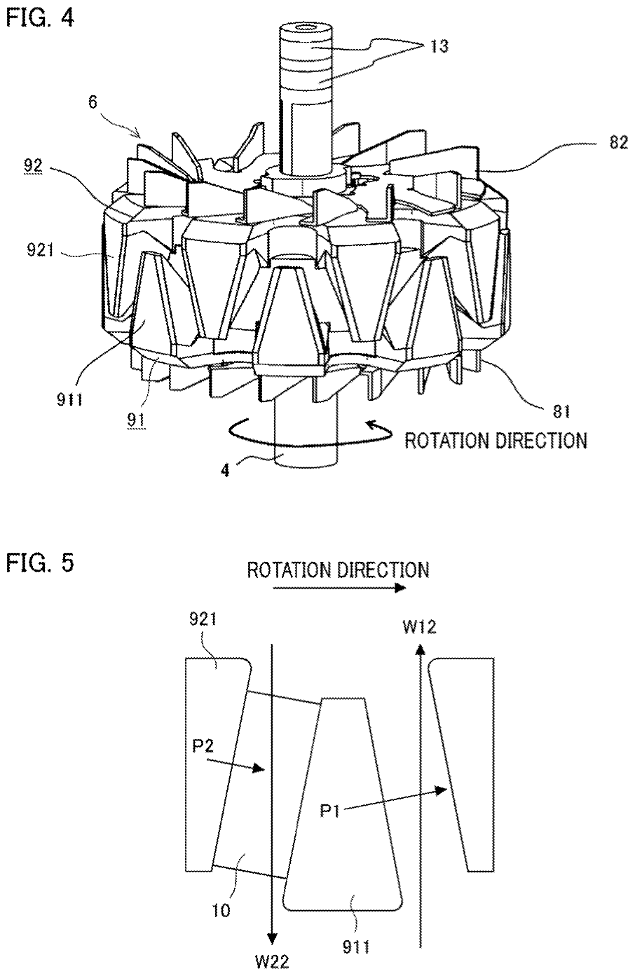

Embodiment 1 will be described on the basis of drawings. FIG. 1 is a relevant part sectional view of an electric rotating machine according to Embodiment 1. FIG. 2 is an outline view showing an example of a rotor according to the present embodiment 1. FIG. 3 is a view in which the rotor in the electric rotating machine according to Embodiment 1 is seen from the power supply unit side. FIG. 4 is an outline view showing an example of the rotor in a longitudinal arrangement in the electric rotating machine according to Embodiment 1. FIG. 5 is a typical view for explaining cooling air flowing through the rotor according to Embodiment 1.

In FIG. 1, a direction in which a shaft extends, that is, an up-and-down direction serves as an axial direction; the radial direction of the rotor and a stator, that is, a right-and-left direction serves as the radial direction; an axial upper direction serves as the rear side; and an axial lower direction serves as the front side. Furthermore, such directions are also referred to as the axial direction, the radial direction, the rear side, and the front side of an electric motor, respectively.

In FIG. 1, the electric rotating machine is constituted by an electric motor 200 and a power supply unit 300 that supplies power to an electric motor 200. The electric motor 200 includes: brackets serving as a housing which is composed of a bracket on the anti-power supply unit side (hereinafter, referred to as a “front bracket”) 1 and a bracket on the power supply unit side (hereinafter, referred to as a “rear bracket”) 2; a stator 3 having a stator core 31 and a stator winding 32; and a rotor 6 having a shaft 4 and a field winding 5. The stator 3 is supported and fixed by one end portion of the front bracket 1 and one end portion of the rear bracket 2; and the rotor 6 is arranged inside the stator 3. The shaft 4 of the rotor 6 is rotatably supported by a bearing 71 provided on the front bracket 1 and a bearing 72 provided on the rear bracket 2; and the rotor 6 is configured so as to be able to rotate coaxially with respect to the stator 3. The power supply unit 300 supplies power to at least either the stator winding 32 or the field winding 5.

A cooling fan 81 is fixed on the anti-power supply unit side (hereinafter, referred to as the “front side”) in the axial direction of the rotor 6; and a cooling fan 82 is fixed on the power supply unit side (hereinafter, referred to as the “rear side”). A pulley (not shown in the drawings) is attached to a load side end portion of the shaft 4, that is, on the outside of the front side of the front bracket 1. The pulley is coupled to a rotation shaft of an engine via a belt (not shown in the drawings) to transfer rotational energy.

The rotor 6 is configured by combining a first magnetic pole 91 (the front side) with a second magnetic pole 92 (the rear side); the field winding 5 is arranged in an internal space formed by the first magnetic pole and the second magnetic pole; the first magnetic pole has a plurality of first claw-shaped magnetic pole portions 911 arranged with a space in the rotation direction of the rotor; the second magnetic pole has a plurality of second claw-shaped magnetic pole portions 921 arranged with a space in the rotation direction of the rotor; a permanent magnet 10 is furnished in some of inter-magnetic pole portions, each existing between the first claw-shaped magnetic pole portion 911 and the second claw-shaped magnetic pole portion 921; and the first magnetic pole 91 and the second magnetic pole 92 are combined so that the first claw-shaped magnetic pole portion 911 and the second claw-shaped magnetic pole portion 921 are alternately engaged.

The permanent magnet 10 is characterized by being arranged adjacent to the advancing side in the rotation direction of the second claw-shaped magnetic pole portions 921 of the second magnetic pole 92.

In the power supply unit integrated electric rotating machine, when the rotor 6 is rotated and driven, the cooling fans 81, 82 are also rotated correspondingly and flow paths are configured as shown by arrows in FIG. 1.

The front bracket 1 includes: a plurality of opening portions 12 (hereinafter, referred to as “exhaust opening portions 12”) which are circumferentially provided in a scattered manner on a portion on the radial outside of the front side cooling fan 81; and a plurality of opening portions 11 (hereinafter, referred to as “air intake opening portions 11”) which are circumferentially provided in a scattered manner on a portion on the front side.

The rear bracket 2 includes: a plurality of opening portions 22 (hereinafter, referred to as “exhaust opening portions 22”) which are circumferentially provided in a scattered manner on a portion on the radial outside of the rear side cooling fan 82; and a plurality of opening portions 21 (hereinafter, referred to as “air intake opening portions 21”) which are circumferentially provided in a scattered manner on a portion on the rear side.

Cooling air W1 includes: cooling air W11 which passes through the air intake opening portions 11 and is discharged from the exhaust opening portions 12; and cooling air W12 which passes through between claw portions of the rotor 6 and is discharged from the exhaust opening portions 22.

Cooling air W2 includes: cooling air W21 which passes through the power supply unit, passes through the air intake opening portions 21, and is discharged from the exhaust opening portions 22; and cooling air W22 which passes through between the claw portions of the rotor 6 and is discharged from the exhaust opening portions 12.

As for the cooling air W1 and the cooling air W2, the cooling air W2 passes through the power supply unit 300; thus, a pressure loss of the cooling air W2 is larger than that of the cooling air W1 and the amount of airflow of the cooling air W1 is larger than that of the cooling air W2. As a result, the amount of airflow of the cooling air W12 which cools the rotor 6 is larger than that of the cooling air W22.

In response to the rotation of a rotor 6, the cooling air W12 is produced by pushing adjacent air (direction: P1) by the first claw-shaped magnetic pole portions 911 and the cooling air W22 is produced by pushing adjacent air (direction: P2) by the second claw-shaped magnetic pole portions 921.

The power supply unit 300 is arranged on the rear side of the electric motor 200 and is fixed to the electric motor 200. The power supply unit 300 includes: an inverter which has a plurality of power semiconductor elements and performs direct current (DC)/alternating current (AC) conversion between a DC power supply and a plurality of phases of windings; a control circuit that performs ON/OFF control of the power semiconductor elements; a pair of brushes 14 which comes in contact with a pair of slip rings 13 provided at a protrusion portion of the shaft 4 protruded from the rear bracket 2 to the rear side; and a power semiconductor element for the field winding, which turns ON/OFF power to be supplied to the field winding 5 via the brush and the slip ring 13. The power semiconductor elements (switching elements) for the field winding performs ON/OFF control by the control circuit and generates heat by the operation of the electric rotating machine.

According to the present embodiment, the permanent magnet is arranged at a position where the cooling air W22 is produced and the cooling air W12 with a large amount of airflow is not blocked; thus, the rotor 6 and the stator 3 can be efficiently cooled by being able to effectively use the cooling air. Further, the cooling air W21 passed through the power supply unit 300 serving as a heat source is not drawn to the rotor 6; thus, cooling efficiency is improved by not using air with a raised temperature as the cooling air. In order to produce the same amount of airflow as a case where the permanent magnet 10 is arranged adjacent to the advancing side in the rotation direction of the claw-shaped magnetic pole portions of the first magnetic pole, the whole pressure loss needs to be reduced and thereby causing an increase in size; while at the same time, a reduction in size and an inexpensive production can be achieved. Further, the power supply unit is less liable to receive the heat from the electric motor by increasing cooling efficiency of the electric motor; thus, cooling efficiency of the power supply unit is also improved, a high heat resistant component does not need to be used, and cost versus performance is improved.

### Embodiment 2

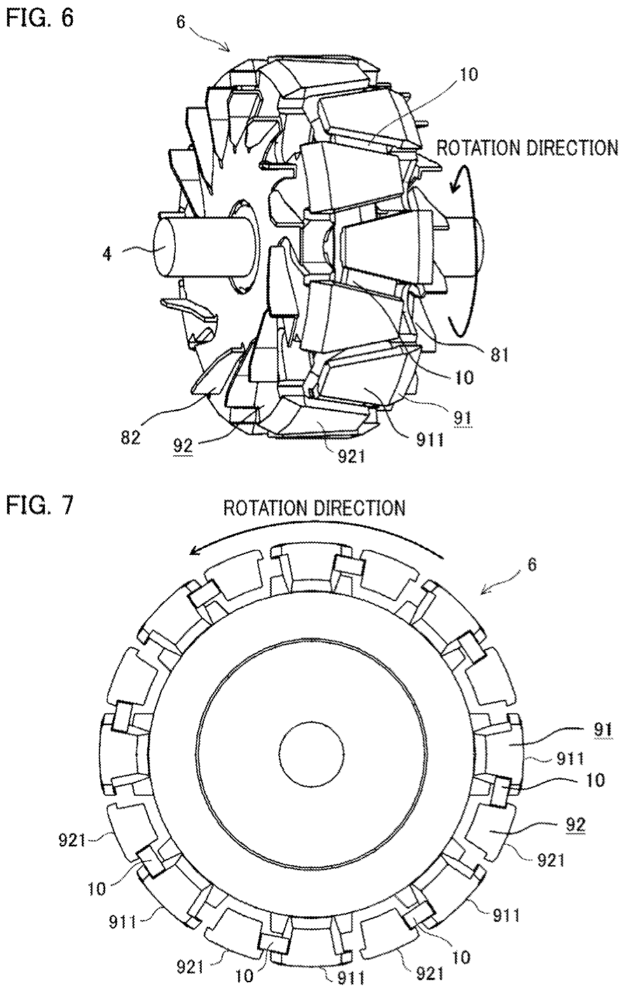

FIG. 6 is an outline view showing a rotor in a lateral arrangement in an electric rotating machine according to Embodiment 2. FIG. 7 is a view in which the rotor is seen from the power supply unit side in the electric rotating machine according to Embodiment 2.

A permanent magnet 10 is arranged adjacent to the advancing side in the rotation direction of claw-shaped magnetic pole portions 921 of a second magnetic pole; and an inter-magnetic pole portion where the permanent magnet 10 is inserted and an inter-magnetic pole portion where the permanent magnet 10 is not inserted are alternately arranged in the rotation direction.

According to the present embodiment, the permanent magnets 10 can be arranged in the maximum number without blocking use efficiency of cooling air; thus, leakage magnetic flux is reduced and output is improved. Furthermore, cooling air W21, which passes through a power supply unit 300 serving as a heat source and is heated, is prevented from entering to a rotor 6 to the maximum extent; thus, cooling efficiency of an electric motor is also increased.

### Embodiment 3

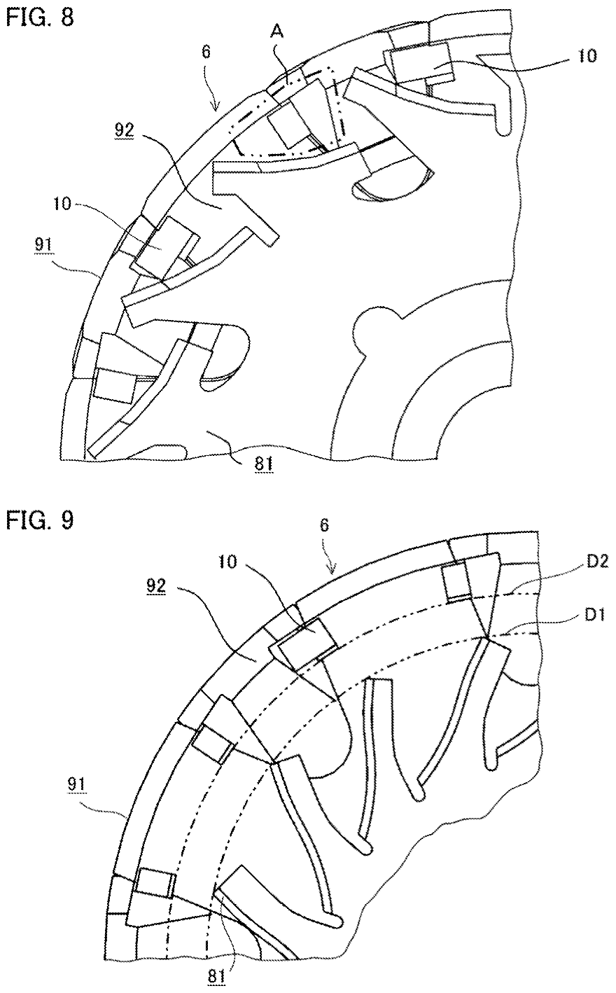

FIG. 8 is an overview view showing a relevant part of a rotor in an electric rotating machine according to Embodiment 3.

A cooling fan 81 is provided with a cutout portion A in the axial direction of an inter-magnetic pole portion where a permanent magnet 10 is not inserted.

According to the present embodiment, cooling performance is improved by enlarging the outer diameter of the fan to increase the amount of airflow. However, when the cooling fan 81 blocks the inter-magnetic pole portion where the permanent magnet 10 is not inserted, cooling air W12 is blocked to reduce the amount of airflow. The cooling air W12 is not blocked by providing the cutout portion A. This reduces a pressure loss of an air path, improves cooling performance of a field winding, and improves output. The same cutout portion A is provided in a cooling fan 82, whereby cooling air W22 is not blocked and the same effects can be obtained.

### Embodiment 4

FIG. 9 is an overview view showing a relevant part of a rotor in an electric rotating machine according to Embodiment 4.

The outer diameter of a cooling fan 81 is smaller than a radial gap of an inter-magnetic pole portion where a permanent magnet 10 is inserted. More specifically, the outermost diameter D1 of the cooling fan 81 is smaller than the innermost diameter D2 of an insertion portion of the permanent magnet 10.

According to the present embodiment, a pressure loss of an air path is reduced without blocking cooling air W12 by reducing the outer diameter of the fan. Further, component cost or weight can be reduced. Furthermore, noise can be reduced. Also, with regard to a cooling fan 82, by using the same configuration, cooling air W22 is not blocked and the same effects can be obtained.

### Embodiment 5

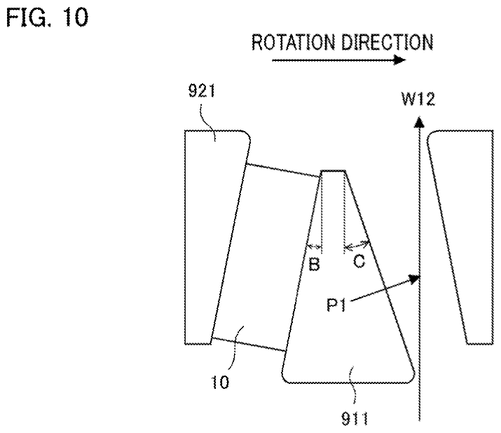

FIG. 10 is an overview view showing a relevant part of a rotor in an electric rotating machine according to Embodiment 5.

A tilt angle of a claw of a first claw-shaped magnetic pole portion 911 on the side C (the advancing side in a rotation direction) where a permanent magnet 10 is not provided is larger than that on the side B (the receding side in the rotation direction) where the permanent magnet is provided. More specifically, with respect to two circumferential surfaces in the axial direction of the shaft which form the claw-shaped magnetic pole portion 911 on the side where a power supply unit 300 is not arranged, the tilt angle C on the advancing side in the rotation direction which is formed by one surface of the two circumferential surfaces and a plane formed by the normal direction of the outermost circumferential side surface of the claw-shaped magnetic pole portion 911, is larger than the tilt angle B on the receding side in the rotation direction which is formed by the other surface of the two circumferential surfaces and a plane formed by the normal direction of the outermost circumferential side surface of the claw-shaped magnetic pole portion 911.

According to the present embodiment, an axial component of a direction P1 in which the first claw-shaped magnetic pole portion 911 pushes adjacent air is increased to promote a flow of cooling air W12, whereby the amount of airflow is increased, cooling performance is improved, and output is improved.

### Embodiment 6

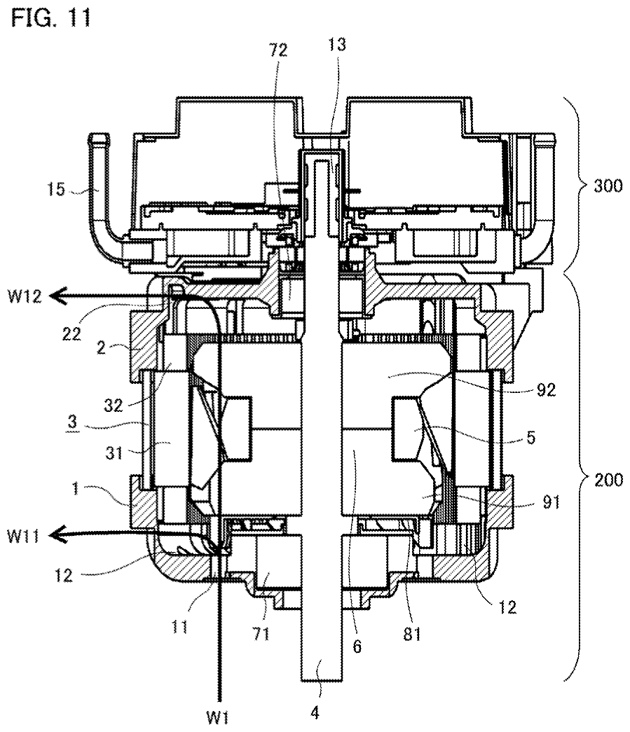

FIG. 11 is a relevant part sectional view of an electric rotating machine according to Embodiment 6.

A power supply unit 300 is cooled by liquid refrigerant supplied to piping for liquid refrigerant 15 provided in the power supply unit 300.

According to the present embodiment, the power supply unit 300 does not need to be cooled by cooling air by the rotation of a cooling fan and thus a cooling fan 82 can be made small and/or can be eliminated, whereby component cost is reduced and the axial height of an electric motor can further be reduced. The cooling fan 82 is not provided in the embodiment of FIG. 11.

In this case, the amount of airflow of cooling air W2 is even smaller than that of cooling air W1 and/or becomes zero. In this situation, when a permanent magnet 10 is arranged at a position where cooling air W12 is produced, only cooling air W11 flows to the electric motor; thus, cooling efficiency is reduced and performance is reduced. Accordingly, the permanent magnet 10 needs to be arranged adjacent to the advancing side in the rotation direction of claw-shaped magnetic pole portions of a second magnetic pole.

The present application describes various exemplified embodiments and examples; however, various features, aspects, and functions described in one or a plurality of embodiments are not limited to specific embodiments, but are applicable to embodiments individually or in various combinations thereof. Therefore, countless modified examples not exemplified are assumed in technical ranges disclosed in the specification of the present application. For example, there include: a case in which at least one constituent element is modified; a case, added; or a case, deleted; and a case in which at least one constituent element is extracted to combine with constituent elements of other embodiments.

What is claimed is:

1. An electric rotating machine comprising:
a rotor configured to include magnetic poles in which a plurality of claw-shaped magnetic pole pieces are provided on the outer circumference thereof, a field winding wound around the magnetic poles, and a shaft that rotates integrally with the magnetic poles and the field winding;
a stator configured to include a stator core arranged in face-to-face relation to the outer circumference of the magnetic poles, and a stator winding wound around the stator core;
a permanent magnet configured to be disposed between the adjacent claw-shaped magnetic pole pieces of the magnetic poles, and to be magnetized in a direction reducing leakage magnetic flux between the adjacent claw-shaped magnetic pole pieces;
a cooling fan configured to be provided on at least one of the axial sides of the shaft in the magnetic poles, and to cool the field winding and the permanent magnet;
brackets configured to contain the stator and the rotor, and to support the shaft rotatably; and
a power supply unit configured to supply power to the stator winding or the field winding,
wherein the power supply unit is configured to be fixed on the axial side of the shaft of the bracket; and
the permanent magnet is configured to be arranged on the advancing side in the rotation direction of the claw-shaped magnetic pole piece of the magnetic pole on the side where the power supply unit is provided.

2. The electric rotating machine according to claim 1,
wherein an inter-magnetic pole where the permanent magnet is disposed and an inter-magnetic pole where the permanent magnet is not disposed, are configured to be alternately arranged in the rotation direction.

3. The electric rotating machine according to claim 1,
wherein the cooling fan is configured to be provided with a cutout on the axial side of the inter-magnetic pole where the permanent magnet is not disposed.

4. The electric rotating machine according to claim 2,
wherein the cooling fan is configured to be provided with a cutout on the axial side of the inter-magnetic pole where the permanent magnet is not disposed.

5. The electric rotating machine according to claim 1,
wherein the outermost diameter of the cooling fan is configured to be smaller than a gap of the inter-magnetic pole where the permanent magnet is inserted.

6. The electric rotating machine according to claim 2,
wherein the outermost diameter of the cooling fan is configured to be smaller than a gap of the inter-magnetic pole where the permanent magnet is inserted.

7. The electric rotating machine according to claim 1,
wherein with respect to two circumferential surfaces in the axial direction of the shaft which form the claw-shaped magnetic pole pieces on the side where the power supply unit is not arranged, a tilt angle on the advancing side in the rotation direction which is formed by one surface of the two circumferential surfaces and a plane formed by the normal direction of the outermost circumferential side surface of the claw-shaped magnetic pole piece, is configured to be larger than a tilt angle on the receding side in the rotation direction which is formed by the other surface of the two circumferential surfaces and a plane formed by the normal direction of the outermost circumferential side surface of the claw-shaped magnetic pole piece.

8. The electric rotating machine according to claim 2,
wherein with respect to two circumferential surfaces in the axial direction of the shaft which form the claw-shaped magnetic pole pieces on the side where the power supply unit is not arranged, a tilt angle on the advancing side in the rotation direction which is formed by one surface of the two circumferential surfaces and a plane formed by the normal direction of the outermost circumferential side surface of the claw-shaped magnetic pole piece, is configured to be larger than a tilt angle on the receding side in the rotation direction which is formed by the other surface of the two circumferential surfaces and a plane formed by the normal direction of the outermost circumferential side surface of the claw-shaped magnetic pole piece.

9. The electric rotating machine according to claim 3,
wherein with respect to two circumferential surfaces in the axial direction of the shaft which form the claw-shaped magnetic pole pieces on the side where the power supply unit is not arranged, a tilt angle on the advancing side in the rotation direction which is formed by one surface of the two circumferential surfaces and a plane formed by the normal direction of the outermost circumferential side surface of the claw-shaped magnetic pole piece, is configured to be larger than a tilt angle on the receding side in the rotation direction which is formed by the other surface of the two circumferential surfaces and a plane formed by the normal direction of the outermost circumferential side surface of the claw-shaped magnetic pole piece.

10. The electric rotating machine according to claim 5,
wherein with respect to two circumferential surfaces in the axial direction of the shaft which form the claw-shaped magnetic pole pieces on the side where the power supply unit is not arranged, a tilt angle on the advancing side in the rotation direction which is formed by one surface of the two circumferential surfaces and a plane formed by the normal direction of the outermost circumferential side surface of the claw-shaped magnetic pole piece, is configured to be larger than a tilt angle on the receding side in the rotation direction which is formed by the other surface of the two circumferential surfaces and a plane formed by the normal direction of the outermost circumferential side surface of the claw-shaped magnetic pole piece.

11. The electric rotating machine according to claim 1,
wherein the power supply unit is configured to be cooled by liquid refrigerant supplied to piping for liquid refrigerant provided in the power supply unit.

12. The electric rotating machine according to claim 2,
wherein the power supply unit is configured to be cooled by liquid refrigerant supplied to piping for liquid refrigerant provided in the power supply unit.

13. The electric rotating machine according to claim 3,
wherein the power supply unit is configured to be cooled by liquid refrigerant supplied to piping for liquid refrigerant provided in the power supply unit.

14. The electric rotating machine according to claim 5,
wherein the power supply unit is configured to be cooled by liquid refrigerant supplied to piping for liquid refrigerant provided in the power supply unit.

15. The electric rotating machine according to claim 6,
wherein the power supply unit is configured to be cooled by liquid refrigerant supplied to piping for liquid refrigerant provided in the power supply unit.
